(19) United States
(12) Patent Application Publication
(10) Pub. No.: US 2022/0397403 A1
(43) Pub. Date: Dec. 15, 2022

(54) SYSTEM AND METHOD FOR DETERMINING A ROUTE FOR A MULTI-DEPOT VEHICLE NETWORK

(71) Applicant: Ocado Innovation Limited, Hatfield (GB)

(72) Inventors: Timothy David BICKLEY, Hatfield (GB); Minh VU DUC, Hatfield (GB); Vasco Augusto SANCHEZ RODRIGUES, Cathays (GB); Emrah DEMIR, Cathays (GB)

(73) Assignee: Ocado Innovation Limited, Hatfield (GB)

(21) Appl. No.: 17/750,765

(22) Filed: May 23, 2022

(30) Foreign Application Priority Data
May 24, 2021 (GB) 2107378.8

(51) Int. Cl. G01C 21/34; G06Q 10/08

(52) U.S. Cl. CPC G01C 21/3415; G01C 21/343; G01C 21/3453; G06Q 10/08355

(57) ABSTRACT

A system and method for routing a fleet of vehicles, the vehicles being based across a plurality of depots. The system and method can determine an optimal route by decomposing the optimisation problem into a plurality of sub-problems, optimising each of the sub-problems and then re-combining the optimised sub-problems to obtain a solution to the routing problem. The solution leads to a more efficient routing of the vehicle fleet, and improves accuracy, efficiency, and functionality of the multi-depot vehicle network system.

### CROSS-REFERENCE TO RELATED APPLICATIONS

This application is related to and claims the benefit of priority to GB2107378.8 filed on May 24, 2021, the entire contents of which is incorporated herein by reference.

### TECHNICAL FIELD

Embodiments relate generally to the field of vehicle routing and more specifically to an apparatus and method for routing a fleet of vehicles located across multiple depots.

### BACKGROUND

In online grocery shopping, customers can book a delivery slot several weeks before the delivery date and are able to update their orders, e.g. adding new products, removing or editing existing products, adding, removing or editing the orders until near to the delivery date. An online grocery order is conventionally delivered in predetermined time window, for example one or two hours. This differs from other online retail services where once an order is placed it cannot be changed. Furthermore, customers may not know the exact deliver day or time slot. In addition, the volume of a typical grocery order is much larger than that of other online orders, and consequently a vehicle can only serve from 15-30 customers. Furthermore, the greater geographical dispersal of online grocery customers means that different routing solutions are required to provide efficient delivery routes, reducing the distance travelled by delivery vehicles and the environmental impact of the delivery routes.

### SUMMARY

An exemplary embodiment is related to a method of routing a plurality of vehicles, wherein each of the plurality of vehicles are assigned to one of a plurality of depots. The method involves a) defining a plurality of routes, each of the plurality of routes comprising a plurality of customer locations, wherein the plurality of customer locations are arranged in a sequence. The method involves b) assigning each of the plurality of routes to one of a plurality of groups of routes. The method involves c) for each of the plurality of groups, modifying one or more of the plurality of routes which comprise that group. The method involves d) determining the operational cost for each of the plurality of groups. The method involves e) combining each of the groups to determine the operational cost for the plurality of routes. The method involves f) executing wherein steps a) to e) are executed within a predetermined time period and repeating steps a) to e) iteratively such that if there is a decrease in the operational cost for the plurality of routes then the modified routes generated in step c) are retained for the subsequent iteration. The method involves g) updating the plurality of routes based on step f) and transmitting the updated plurality of routes to a vehicle.

An exemplary embodiment involves a system for determining a route for a vehicle. The system includes a scheduling module configured to define plural routes, each route including a node. The system includes a routing module configured to determine a route for a vehicle by iteratively performing the following steps: a) assign each route to a group, each group being defined by constraints based on departure and/or arrival time of a vehicle at a node; b) determine, via an objective function, an operational cost for each group based on decision variables associated with: a number of vehicles required to reach a predetermined number of nodes within time, t; arrival time of a vehicle at a node occurring within an arrive time window; distance a vehicle travels from node to node; and/or time required for a vehicle to travel from node to node; c) modify a route for a group; d) combine the plural groups and determine, via the objective function, an operational cost for the combined-plural groups. The routing module is configured to: retain a modified route for the next iteration when the operational cost for the combined-plural groups deceases; and/or discard a modified route when the operational cost for the combined-plural groups increases.

An exemplary embodiment relates to a method for determining a route for a vehicle. The method involves: a) defining plural routes, each route including a node; b) assigning each route to a group, each group being defined by constraints based on departure and/or arrival time of a vehicle at a node; c) determining an operational cost for each group; d) modifying a route for a group; e) combining the plural groups and determining an operational cost for the combined-plural groups; iterating steps a)-e). The method retains a modified route for the next iteration when the operational cost for the combined-plural groups deceases; and/or discards a modified route when the operational cost for the combined-plural groups increases.

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 is a schematic diagram of a plurality of delivery depots and a plurality of different customer locations;

FIGS. 2a-2c show schematic diagrams of a number of intra-route and inter-route moves;

FIG. 3 shows a schematic depiction of an acyclic move corresponding to 3 routes;

FIG. 4 shows a schematic depiction of an acyclic move corresponding to 3 routes;

FIG. 5 shows a schematic depiction of a normal and a reversed replacement/insertion move;

FIGS. 6a-6c show schematic depictions of the number of orders, the number of routes and the drops per van value for a given time period;

FIG. 7 shows a graphical depiction of the variation of the drop per van value throughout a day;

FIG. 8 shows a graphical depiction of the variation of the number of routes with drops throughout a day;

FIG. 9 shows schematic depiction of a computer device which can be used to implement an embodiment of the disclosed method;

FIG. 10 shows an exemplary system configuration for determining a route for a multi-depot vehicle network;

FIG. 11 shows a process flow diagram for an embodiment of the system for determining a route for a multi-depot vehicle network; and

FIG. 12 shows a data flow diagram for an embodiment of the system for determining a route for a multi-depot vehicle network.

### DETAILED DESCRIPTION OF EMBODIMENTS

Embodiments relate to a method of routing a plurality of vehicles, each of the plurality of vehicles being assigned to one of a plurality of depots, the method comprising the steps of: a) defining a plurality of routes, each of the plurality of routes comprising a plurality of customer locations, wherein the plurality of customer locations are arranged in a sequence; b) assigning each of the plurality of routes to one of a plurality of groups of routes; c) for each of the plurality of groups, modifying one or more of the plurality of routes which comprise that group; d) determining the operational cost for each of the plurality of groups; e) combining each of the groups to determine the operational cost for the plurality of routes; wherein steps a) to e) are executed within a predetermined time period and are repeated iteratively such that if there is a decrease in the operational cost for the plurality of routes then the modified routes generated in step c) are retained for the subsequent iteration.

If there is an increase in the operational cost for the plurality of routes then the modified routes generated in step c) may be discarded for the subsequent iteration. For each of the plurality of groups the one or more modified routes may be selected randomly from the plurality of routes which comprise each group.

Step c) may comprise selecting one or more routes from each group of routes and moving one or more customer locations from a first route in a group of routes to a second route in that group of routes. Step c) may comprise selecting one or more routes from each group of routes and re-ordering one or more customer locations in the selected route(s). Step c) may comprise selecting one or more routes from each group of routes and exchanging a subset of customer locations from a first route in a group of routes with a subset of customer locations from a second route in that group of routes.

If a new customer location is to be inserted into a route in step a), the customer location may be inserted into a new route. A new customer location may be randomly inserted into a new customer route in step a). A new customer location may be inserted into a new customer route in step a) if a randomly generated number is less than a predetermined threshold value. A new customer location may be inserted into a route in step a), the customer location may be inserted into an existing route.

Step c) may comprise a process of simulated annealing.

Some embodiments relate to an apparatus comprising one or more processors, one or more volatile data storage units and one or more non-volatile data storage units, the apparatus being configured, in us, to perform a method as described above.

Some embodiments relate to a data carrier device comprising computer executable code for performing a method as described above.

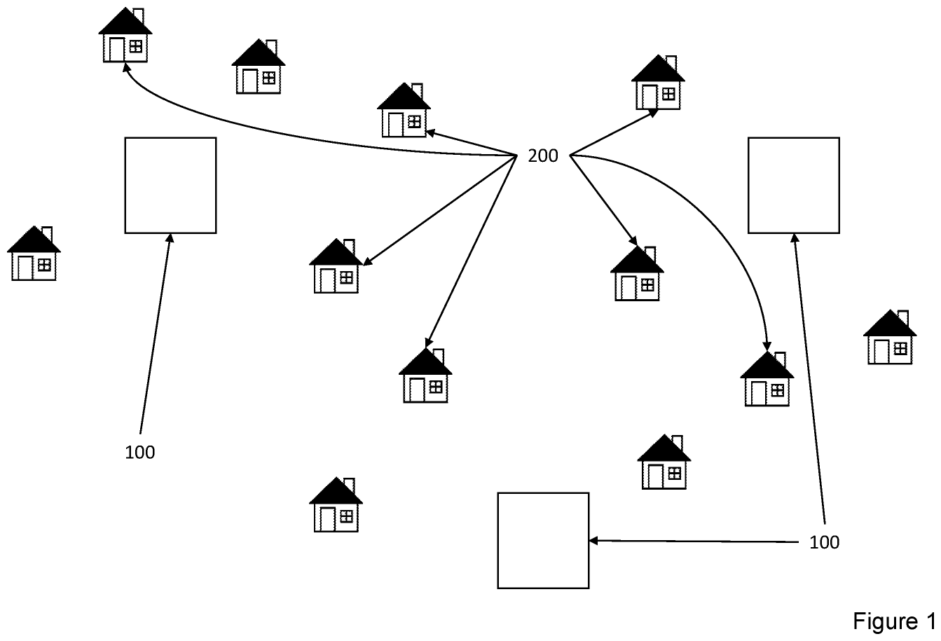

FIG. 1 shows a schematic depiction of a plurality of delivery depots 100 which are used to make deliveries to a number of different customer locations 200. It can be seen that it may be possible to deliver to each of the customer locations from two, or all, of the delivery depots. For instance, the systems and methods disclosed herein can be used to devise a route(s) for any number of vehicles v operating from delivery depots 100 to make deliveries to any number of customer locations 200. Some embodiments can include controlling any one or combination of the vehicles v via the route(s).

The problem may be described formally by D denoting a dynamic of inputs which is specified by a set of customers C={1, 2, . . . , c}, a set of depots [symbol] ={1, 2, . . . , d}, a set of homogeneous vehicles V={1, 2, . . . , v} and a set of available product types P={1, 2, . . . , p}, e.g. ambient, chilled or frozen products. Information associated to each customer pc∈C includes: a volume of demand q≥0 for each p∈P, 1-hr time window [e_{c}, l_{c}] chosen by customer indicating when the customer wants his/her orders to be delivered, and the parameter c_{cgz} indicates whether the customer is located in a congestion charge zone. While the company tries to deliver orders to customers within their time windows as much as possible, it is unavoidable that some orders will be delivered earlier and later than expected. To maintain the quality of service, a penalty cost is assigned for each order that is delivered out of its time window. The penalty cost measures the dissatisfaction of customers and it helps to prevent too early and too late delivery.

Each vehicle k∈V (k is vehicle k of the set of vehicles V) starts from a depot oₖ∈ [symbol] (oₖ is depot oₖ of the set of depots [symbol] ) and ends the trip at a depot dₖ∈ [symbol] , and having working time window [eₖ, lₖ]. The end depot may be different from the start depot, or the vehicle may return to the depot from which it started. Assuming homogeneous vehicles, capacity for volume of type p is denoted as Qₚ. Vehicle k is not available at the depot oₖ at time t<eₖ and if the vehicle returns dₖ later than lₖ, a penalty occurs. Travel time (including parking time) between two locations

i,j∈C⁺=C∪

[symbol]

is denoted by the t^{k}ᵢⱼ, depending on (e.g.

$${travel}_{l}$$

time on training route or new driver is different with normal travel time). Also, service time at customer c is denoted by sₖ^{c}. We denote [bₑ^{k}, bₗ^{k}] the time window that the vehicle k should take a break of length bₖ if this vehicle returns back to the depot later than bₗ^{k}.

For each route k∈R, (k is route k in the set of routes R) we define:
A binary variable rₖ∈{0, 1} which indicates whether the route k is used or not.
A binary variable zᵢ^{k}∈{0, 1} for i∈C which defines whether route k serves customer i or not.
Continuous variables, aᵢ^{k}, ssᵢ^{k}, seᵢ^{k}, dᵢ^{k} where they present arrival time, start service time, end service time and departure time at customer i.

For each arc (i,j), we define:
A binary variable xᵢₖ^{k}∈{0, 1} which indicates whether the route k visit customer j just immediately after visiting customer i.
A binary variable bᵢⱼ^{k}∈{0, 1} which indicates whether the break for route k happens while traveling from i to j.
A Continuous variable yᵢⱼ^{pk} which presents the volume of commodity of type p transferred by vehicle k when traveling from customer i to customer j.
A binary variable wᵢⱼ^{k}∈{0, 1} which indicates whether the break happens while traveling from i to j.
A binary variable cczₖ∈{0, 1} which indicates there is at least one customer located in a congestion charge zone or not.

The objective function is the sum of different cost components for each route: out of time windows cost, congestion charge zone cost, drive time cost, late back cost, capacity violation cost, and vehicle fixed cost and can be assumed to be a black box function. The objective function is the total cost of several functions associated to each route and customers that the route serves. For each route rₖ, out of time window cost function ƒ^{k}_{TW}(rₖ) evaluates the penalty when a customer i in route k is not served within an extended time window which is obtained by modifying customer's time window. Travel time cost function ƒ^{k}_{TT}(rₖ) is a function of total drive time. Late back cost function ƒ^{k}_{LB}(rₖ) evaluates the penalty when a vehicle comes back to its depot later than the its ending time window. Capacity violation cost function ƒ^{k}_{FC}(rₖ) measures the violation in term of capacity. Vehicle fixed cost function ƒ^{k}_{FC}(rₖ) is the cost of using one unit of vehicle. Congestion charge zone cost function ƒ^{k}_{CCZ}(rₖ) evaluates the penalty cost when a vehicle visits a customer who lives in a congestion charge zone area. The objective function is expressed below in equation [1]:

$$min {\sum }_{k ∈ ℛ} {f}_{FC}^{k} ( {r}_{k} ) + {f}_{TW}^{k} ( {r}_{k} ) + {f}_{LB}^{k} ( {r}_{k} ) + {f}_{TT}^{k} ( {r}_{k} ) + {f}_{C}^{k} ( {r}_{k} ) + {f}_{CCZ}^{k} ( {r}_{k} ) \qquad ( 1 )$$

$${\sum }_{k ∈ ℛ} {z}_{i}^{k} = 1 , ∀ i ∈ 𝒞 , \qquad ( 2 )$$

$${z}_{i}^{k} \leq {r}_{k} , ∀ k ∈ ℛ , i ∈ 𝒞 \qquad ( 3 )$$

$${z}_{i}^{k} = {\sum }_{( ij ) ∈ A} {x}_{ij}^{k} = {\sum }_{( ji ) ∈ A} {x}_{ji}^{k} , ∀ i ∈ 𝒞 , \qquad ( 4 )$$

$${ccz}_{k} = 1 if ∃ i ∈ 𝒞 , {z}_{i}^{k} = 1 and i is a congestion charge zone customer \qquad ( 5 )$$

The constraint shown in equation [2] ensures that each customer must be served by exactly one vehicle. Constraint [3] makes sure that a vehicle k can serve a customer i if and only if this vehicle is actively in use. Finally, constraint [4] ensures that if customer i is visited by vehicle k, then this vehicle must leave the customer. Time-window-related constraints are as follows.

aₒ_{ₖ}^{k}≥eₖrₖ,∀k∈ [symbol] , (6)

aᵢ^{k}+M(1−xⱼᵢ^{k})≥dⱼ^{k}+tⱼᵢ^{k}xⱼᵢ^{k}+bₖwⱼᵢ^{k},∀k∈R, (7)

aᵢ^{k}≤ssᵢ^{k}≤seᵢ^{k}−sᵢ^{k}−zᵢ^{k}≤dᵢ^{k}−sᵢ^{k}zᵢ^{k} (8)

Constraint [6] guarantees that the earliest departure time of vehicle k is at least Eₖ if this vehicle is in use. Constraint [7] ensures that if customer i is visited after customer j, then the condition between the service time at i and the departure time from j must be met. Finally, constraint [8] enforces the conditions between the arrival time, start service time, end service time and departure time at customer i if it is served by vehicle k. In this constraint, the term sᵢ^{k}zᵢ^{k} denotes service time at customer i.

$${\sum }_{( ij ) ∈ A} {w}_{ij}^{k} = 1 if {a}_{{d}_{k}}^{k} \geq {d}_{{o}_{k}}^{k} + {b}_{c}^{k} {r}_{k} ∀ k ∈ ℛ , \qquad ( 9 )$$

$${w}_{ij}^{k} \leq {x}_{ij}^{k} , ∀ k ∈ ℛ , ( i , j ) ∈ A , \qquad ( 10 )$$

$${d}_{{o}_{k}}^{k} + {X}_{k} {r}_{k} \leq ( {d}_{i}^{k} + {t}_{ij}^{k} {x}_{ij}^{k} ) + M ( 1 - {w}_{ij}^{k} ) , ∀ k ∈ ℛ , ( i , j ) ∈ A , \qquad ( 11 )$$

$${d}_{i}^{k} \leq {d}_{{o}_{k}}^{k} + {Y}_{k} {r}_{k} + M ( 1 - {w}_{ij}^{k} ) , ∀ k ∈ ℛ , ( i , j ) ∈ A , \qquad ( 12 )$$

Constraint [9] ensures that a break must happen exactly once in an arc visited by vehicle k. An arc is a line connecting two nodes in a graph and represents the route taken between two customer locations. Constraint [10] states that break happens when traveling from i to j if this arc is actively chosen by route k. Since break of route k must happen in the interval [Xₖ, Yₖ] after the departure, constraints [11] and [12] make sure that conditions happen. Constraint [11] ensures that if vehicle k takes a break when traveling from customer i to customer j, at least Xₖ units of time has passed. Constraint [12] ensures that if the break happens in the arc (i,j) then departure time from i, d^{k} must be no later than dₒₖ^{k}+Yₖ.

$${y}_{ij}^{pk} \leq {Q}_{p} {x}_{ij}^{k} , ∀ p ∈ 𝒫 , k ∈ ℛ , ( i , j ) ∈ A , \qquad ( 13 )$$

$${\sum }_{( ij ) ∈ A} {y}_{ij}^{pk} - {\sum }_{( ji ) ∈ A} {y}_{ji}^{pk} = {q}_{i}^{p} {z}_{i}^{k} , ∀ i ∈ 𝒞 , k ∈ ℛ , p ∈ 𝒫 , \qquad ( 14 )$$

Constraint [13] ensures that the active amount of product p at any moment cannot exceed the capacity Qₚ on each travel arc. Constraint [14] ensures that if vehicle k serves customer i, then the demand qᵢ^{p} must be satisfied.

The algorithm used can be seen as a hybrid algorithm comprising multiple elements. Algorithm 1 (see below) called the Parallel and Decomposition-based Simulated Annealing Approach for the Dynamic Multiple Depot Vehicle Routing Problem with Time Windows (D-MDVRPTW), or shortly PDSA-D-MDVRPTW, summarizes the main steps of our approach:

Algorithm 1 PDSA-D-MDVRPTW

Require: D-MDVRPTW instance, a timelimit X, and stopping conditions

| | |
|---|---|
| 1: | while stopping conditions are not met do |
| 2: | Update the input of the problem P. |
| 3: | Synchronise with the best solution, s_{b} and the current solution, s_{c}, Algorithm 3. |
| 4: | Decompose the whole problem P into several subproblems SP₁, . . . , SPₘ based the current |
| | solution. |
| 5: | Solve subproblems SP₁, . . . , SPₘ in parallel for X seconds; and obtain solutions s₁, . . . , sₘ |
| 6: | Merge the solutions of the subproblems s₁, . . . , sₘ and update s_{c}. |
| 7: | Update the best solution if s_{c} is better than s_{b}. |
| 8: | end while |

Our algorithm comprises of several major steps. First, the optimizer will update the input using information collected in a predetermined time period, for example 20 seconds. Other time periods can be used based o design criteria—e.g., the system can could collect data (or update orders) more frequently (but this would require more computing power) or less frequently (leading to a less optimal solution. The updating may include adding new orders, editing existing orders or canceling existing orders, etc. This step is handled by an existing procedure (e.g., customer orders can be collected via web interface or an app and the inventive method/system disclosed herein provides a new way of optimising the collected customer order data). Since the problem is modified, we need to synchronize the problem and the solutions we are having. After the synchronization, we continue solving the problem. We decompose the whole problem into several independent subproblems and solve those subproblems in parallel. After the predetermined time period (e.g., 20 seconds), we collect the solutions to the subproblems and merge them to obtain the solutions to the original problem. Thus, the inventive system/method can divide the problem into subproblems and execute the algorithm for 20 seconds to collect solutions to the subproblems. If a better solution is found, we update the best solution. The optimization process will stop after 24 h, which simulates customers' activities and optimizing process in the day before the delivery day. For instance, there may be a cut-off the evening before delivery day, at which point orders can no longer be added or amended. At this point the current optimisation can be frozen and the order & route data is used to pick orders. In any event, this should not be taken to mean that the optimisation process only runs for 24 hours (although it can be limited to 24 hours is desired). It could run from the first orders being accepted for a given date [typically a customer can only book a slot a few weeks ahead] until the cut-off point.

The optimizer synchronizes input after every 20 seconds due to the modification of data (e.g., new orders, or modification of existing orders, etc.). The main steps of this procedure is shown below in Algorithm 2. The optimizer first removes all canceled orders (the customers canceled their bookings); or a route k is not available. For instance, the optimizer can cancel routes not available—e.g., if there are not enough vehicles or drivers available to run all of the routes then a route can be cancelled. It is since, for example, a customer fulfillment center is going to collect orders that are delivered by this route. Therefore, the list of customers served by this route is fixed and the status of the route is set to be unavailable for further optimizing. Next, information of modified orders and routes are updated in the current problem and solution. The optimizer updates the solution. Finally, the optimizer inserts unassigned orders to the current solution.

Algorithm 2 Update a solution when the problem is changed

```
Require: A solution s.
  1: Remove all canceled orders and all unavailable routes from s.
  2: Update the information of modified orders and modified routes in s.
  3: Refresh the solution s - recalculate arrival times, violations, etc.
  4: Insert unassigned orders into s and update the objective function.
```

When a customer wants to book a slot for delivery, the optimizer system determines a set of slots that are available for the delivery slot selection. After the confirmation of customers regarding the booking of new orders, a route-assignment procedure tries to insert orders that were confirmed during the last optimization iteration into available routes. Those available routes include routes with orders and routes without orders (empty routes). While we know that using as many as possible routes will help handle violations effectively, this will, however, reduce the average number of orders per route (e.g., drop-per-van value (DPV). DPV is an important key performance indicator (KPI) that is used to evaluate the effectiveness of the proposed routing plan, and thus it may be desired to keep DPV high or at least prevent DPV from reducing.

We develop the following simple rule to maintain the average number of orders per route (drop-per-van value or DPV). DPV decreases only when a new empty route is used to deliver orders;

therefore, we allow to use empty routes if the following condition is met: given a parameter α_{DPV}, the number of unassigned orders nbUnassignedOrders, the number of assigned orders nbAssignedOrders and the number of active routes nbActiveRoutes, we allow to use an empty route for the delivery if and only if

$${∝}_{DPV} \leq \frac{nb Unassigned Orders + nb Assigned Orders}{1 + nb Active Routes} \qquad ( 15 )$$

We develop two strategies for the value of α_{DPV}. In the first strategy, this value is fixed to a predefined value DPI/historical in the last day before the delivery (the last day before delivery being the cut-off time for orders). With this strategy, we assume α_{DPV} to be 0 in the first 22 days, and DPV_{historical} in the last day. Use of 22 days is for exemplary purposes only. Use of 22 days in this example is selected based on an assumption that a customer can book a slot 23 days ahead for delivery. The predefined value can be estimated using recent historical data. In the second strategy, we try to adjust α_{DPV} dynamically with a small value, e.g. 0.1, each time some condition are met. The first condition is the percentage of time window violations. If this percentage is smaller than a predefined value, e.g. twViolationPercentage, and the condition [15] is valid, we increase α_{DPV} by 0.1. Otherwise, we decrease α_{DPV} by 0.1. The reason is that we expect that when decreasing α_{DPV}, the optimizer has more chance to use empty routes which explicitly helps with handling violations.

Due to the size of the problem, we consider parallel and decomposition as a component of our algorithm. The Partial Optimization Metaheuristic Under Special Intensication Conditions (POPMUSIC) framework decomposes a solution s into several parts named s₁, s₂, . . . , sₘ, and then, aggregates some parts to define a subproblem. If parts and sub-problem are well defined, every improvement of a sub-problem corresponds to an improvement of the whole solution s. Algorithm 3 below indicates how POPMUSIC works.

Algorithm 3 POPMUSIC framework

Require: A solution s composed of parts s [symbol] , . . . sₚ.

| | |
|---|---|
| 1: | Set A ← ø |
| 2: | while A ≠ {s [symbol] , . . . , sₚ} do |
| 3: | Select a seed part sᵢ ∉ A |
| 4: | Create a subproblem Rᵢ consists of r parts s [symbol] , . . . sᵢ, |
| | most related to sᵢ |
| 5: | Optimise Rᵢ |
| 6: | if Rᵢ has been improved then |
| 7: | Update S and corresponding parts |
| 8: | Set A ← A\{s [symbol] , . . . , s [symbol] } |
| 9: | else |
| 10: | Set A ← A∪ {sᵢ} |
| 11: | end if |
| 12: | end while |

[symbol]

indicates data missing or illegible when filed

When applying this framework to MDVRPTW, given a solution s, we call Algorithm Parallel-Decomposition(s) to generate subproblems using the solution routes depicted by s. Given each seed route r, Algorithm Subproblem-generation to generate a subproblem of size M given a seed route r. Each subproblem is defined by a set of routes and a set of orders delivered by those routes. The details of how this step is performed is discussed in the next section. We note that when a route is selected to define a sub-problem, all orders of this route is also selected. At the end of this algorithm, we obtain a set of independent subproblems {SP₁, SP₂, . . . , SPₘ} that will be optimized parallel and independently.

Algorithm 4 PARALLEL-DECOMPOSITION(S)-Parallel decomposition using a solution s

Require: A solution s, a size of the subproblem M.

| | |
|---|---|
| 1: | [symbol] ₛ ← the set of routes in s. |
| 2: | m ← 0 {The number of subproblems} |
| 3: | while some stopping conditions are not met do |
| 4: | Select a seed route r ϵ [symbol] ₛ |
| 5: | m ← m + 1 |
| 6: | Generate SPₘ by Algorithm SUBPROBLEM-GENERATION(r, [symbol] ₛ, M) |
| 7 | Exclude from [symbol] ₛ all routes in SPₘ |
| 8: | end while |
| 9: | return {SP₁, SP₂, . . . , SPₘ} |

Algorithm 5 shows how we generate a subproblem. Given a seed route r and the set of available routes R, the procedure Route-Selection (r, Rₛ, M) selects routes and orders and it stops when there are at least M customers. There are scenarios that the procedure may not return enough customers, it happens, for example, some neighbor routes has been selected to define other sub-problems, therefore, we try to add other routes to this subproblem. To do so, if it is the k-th times we call this procedure to define the m-th subproblem, we will call it with a seed route which is the k-th worst route in SPₘ. The reason for it is because we favor optimize bad and violated routes which are depicted by high costs.

Algorithm 5 SUBPROBLEM-GENERATON(m, r, [symbol] ₛ, M)-Generate a subproblem of size M

Require: A seed route r, a set of routes to select [symbol] ₛ, the maximum size of the subproblem M.

| | |
|---|---|
| 1: | SP ← ROUTE-SELECTION(r, [symbol] ₛ, M) |
| 2: | if \|SP\| < M then |
| 3: | k ← 2 |
| 4: | while \|SP\| < M do |
| 5; | Remove from [symbol] [symbol] all routes in SPₘ |
| 6: | r ← the k-th worst route in SPₘ |
| 7: | M ← M − \|SP\| |
| 8: | Add to SP the routes returned by ROUTE-SELECTION(r, [symbol] _{b}, M) |
| 9: | end while |
| 10: | end if |

[symbol]

indicates data missing or illegible when filed

To avoid repeated same subproblems for a given seed route, it has been proposed to use a (75%, 25%) strategy. Precisely, given M the size of the subproblem, routes are selected that are closest to r where those routes consist of about 75%×M customers. The remaining 25% M customers are selected randomly. While this strategy ensures the randomness of subproblems, the random selection of 25% M customers may make the optimisation process less effective.

It is particularly true if those 25% M customers are far away from the seed route and other routes of the subproblem. To handle this issue, we propose a (120%, 100%) strategy that first, we generate a list of routes serving 120% M customers that are closest to r. Then, we select randomly routes having about M customers among those 120% M customers. Thus, the generated subproblem ensures random customers while are not too far from the seed route.

Algorithms 6 ROUTE-SELECTION(r, [symbol] [symbol] , M)-Select closest routes

Require: A seed route r, a set of routes to select [symbol] [symbol] , the maximum size of the subproblem M.

| | |
|---|---|
| 1; | Calculate the distances from the seed route r to other routes (or orders) and store in a list [symbol] |
| 2: | Sort the distances in [symbol] increasingly. |
| 3: | [symbol] [symbol] ← ∅ |
| 4: | for each element c in [symbol] do |
| 5: | r [symbol] ← the route corresponding to element e. |
| 6: | If r_{α} ∉ [symbol] _{α}, add r_{c} to [symbol] _{α}. |
| 7: | Stop if the number of customers corresponding to the routes in [symbol] _{α} exceed M (1 + α) |
| 8: | end for |
| 9: | Shuffle the element in [symbol] α |
| 10: | Return the first k routes of [symbol] _{α} that constitues M customers. |

[symbol]

indicates data missing or illegible when filed

Algorithm 7 shows how we merge solutions to subproblems to obtain the solutions to the whole problem. Since we select a subset of routes and the orders routed by those routes to define subproblems, to obtain the merged solution, we just replace the old routes in the whole solution by the new routes obtained after optimising the subproblems. We do so for each subproblem that we can find a better solution.

Algorithm 7 Obtaining improved solution by merging solutions to subproblems

Require: A solution s to the whole problem, solutions {s₁, s₂, . . . , sₘ} to subproblems

| | {Sp₁, SP₂, . . . , SPₘ}. |
|---|---|
| 1: | for k ← 1 to m do |
| 2: | if a better solution to SPₖ is found then |
| 3: | [symbol] ₖ ← set of routes defining subproblem SPₖ |
| 4: | Replace each route r ∈ [symbol] ₖ of s by the corresponding route in sₖ. |
| 5: | end if |
| 6: | end for |
| 7: | return s |

The question of how to select routes to define subproblem is a crucial one as a poor selection of routes can lead to non-useful subproblems that are hard to improve. Since the time window is an important feature of the problem, we take into account this value while evaluating measures. However, we do not attempt to convert (location, time window) into a temporal-spatial value since it loses the time window property which is a crucial feature in our problem. Also, such conversion tends to be highly computationally intensive.

We summarize decomposition approaches that we use in our algorithm. We calculate distance between entities where each entity is either a route (aggregated mode) or an order (segregated mode). As we take into account time window while evaluating distances, we cannot use the aggregated entity concept such as the center of gravity to map a route into a fake order. The distance between two customers is the average of the travel time from the first customer to the second order and the travel time from the second customer to the first customer.

An approach which only uses travel times or distances to select routes is not entirely appropriate. It is possible that two customers are close to each other but have completely different time slots, e.g. morning time slot and afternoon time slots. To avoid the situation, we use time windows to verify whether the distance between two customers could be considered in the step of defining subproblems. Given two customers i and j with service time windows [eᵢ, lᵢ] and [eⱼ, lⱼ], we assume that those two customers are neighbors, if they are not too far from each other and we can serve one customer after another. In other words, it is either
1) eᵢ+tᵢⱼ≤lⱼ (it is possible to visit i before visit j without violating time windows at j) and eᵢ+MAXT≥lⱼ (i and j are not too far), or
2) eⱼ+MAXT≥lₐ and eⱼ+tⱼᵢ≤lᵢ.

Here, MAXT denotes the maximum difference between the opening time window of customer i and the closing time windows of customer j. For example, if the width of the time slot is one hour (3,600 s), we can set MAXT to 2 hours (7,200 s). The reason is we believe that in any good solution, it should not serve two customers i and j one after another when they are too far from each other. We use these conditions to restrict the calculations of the distances between customers. We use the following rules to evaluate distances from routes to routes, routes to orders and orders to routes:
Route-to-route distance: the distance is the average distance between orders and orders of the first and second route that are compatible.
Route-to-order distance: the distance is the average distance between orders of the route and the other order that are compatible.
Order-to-route distance: the distance is the average distance between the order and the orders of route that are compatible.

The simulated annealing (SA) (see algorithm 8 below) is executed until stopping condition is reached, which is the predetermined time period (e.g., 20 seconds) referred to above. In each iteration, we select randomly a move, which is an intra-route move or an inter-route move, following some probabilities, and then perform that move. If the move is accepted, we update the solution. We accept a move if it either results in a better solution or it only introduce a small amount of lost in term of solution quality. Let ƒ (s) and ƒ (s¹) is the cost before and after a move m; we accept m and s¹ if ƒ (s¹)−ƒ (s)≤Δ where Δ is a parameter adjusted by some rules. In our implementation, Δ is at most 30 in any case. The value of Δ is reset after a fixed amount of iterations.

Algorithm 8 Simulated Annealing ramework

| Require: A solution s to MD-VRPTW problem. | |
|---|---|
| 1: | while stopping condition is not met do |
| 2: | Select randomly a move m following some probabilities. |
| 3: | Perform the move m and evaluate the cost f{s′) of the new |
| | solution s′ |
| 4: | If the move is accepted, accept the new solution; s ← s′. |
| 5: | end while |

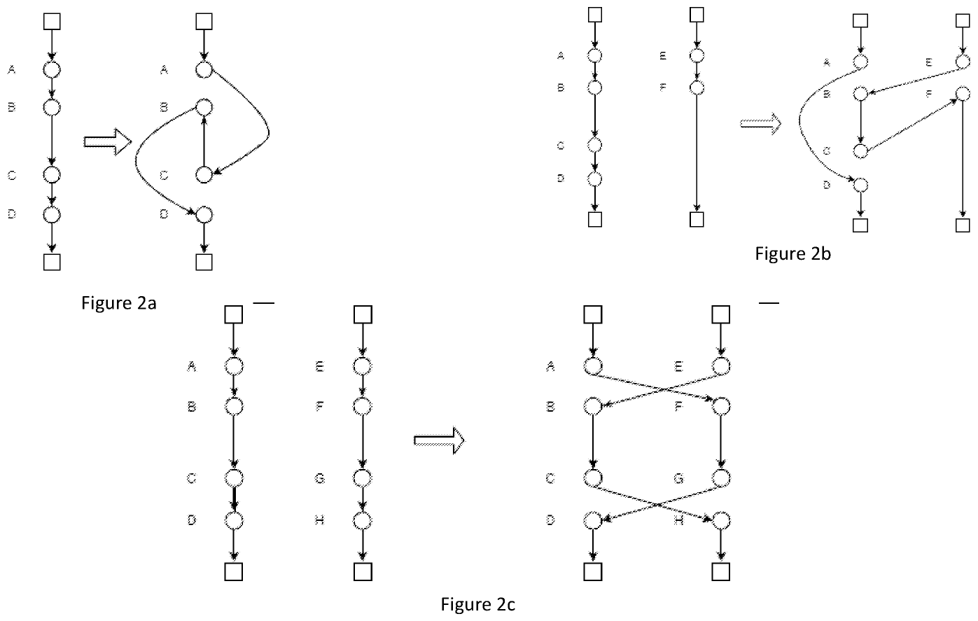

Given solutions to subproblems, we improve those solutions using a SA algorithm that we develop for our problem. The local search moves include intra-route move and inter-route moves to optimize the current solution. These moves are shown schematically in FIGS. 2a-2c. The intra-route moves optimize the order of the visit in each route while the inter-route moves swap customers between routes to find better routes. A 2-opt move (FIG. 2a) reverses the visiting orders of a sequence of customers in a route. To do it, the move destroys two edges of a route in a solution, and recreate this route by making two new edges. Then, inverts the part of a solution in such a way that the resulting solution is still a tour. The relocate operator route (FIG. 2b) moves a sequence of customer locations from one route to another route. The cross operator route (FIG. 2c) swaps the end portions of two vehicle routes (which may be thought of as a swap of two sequences of consecutive nodes from the two routes) and preserves the order of customer locations within each route.

Handling time window violations is one of the important tasks in our problem. Since the problem is dynamic, update of the input data can significantly change the quality of the current solution; particularly during the time period that there are many customers booking their orders, e.g. the day before the delivery. Therefore, we need a mechanism to reduce violations as quickly as possible. The violations include:
i) early-visit violation, it means that a vehicle serves a customer before customer's time window;
ii) late-visit violation, it means that a vehicle serves a customer after customer's time window; and
iii) finally, a vehicle returns back to the depot later than its close time window.

To handle violations, we extend the relocation operators and cross operators. The main idea is that we try to move customers that incurs late violations or late back violations to other routes; or we relocate customers from other route to a route that has early violations. In addition to relocation operators, we also extend cross operators to handle violations. With cross-operators, we simply restrict ourselves to the condition that at least one of two routes that are used in this operator violates time window conditions. Regarding handling violations with relocation moves, to handle late-back violation of a route, we determine a set of customers that the relocation of those customers to other routes will eliminate the late-back violation of this route. Algorithm 9 (see below) explains the main steps of our procedure to handle this type of violation. First, we determine if a route has a time window violation; then, depending on the type of violations, the corresponding moves are executed. To handle early violations, one of the approaches that we use is that we try to insert some customers before that last customers that have early violations. Finally, to handle late visit violation, we try to relocate those late-visit customers to other routes (see below).

Algorithm 9 Handling late-back violation with RELOCATION move

Require: A route r with late-back violation.

| | |
|---|---|
| 1: | Choose a customer c in r that removes this customer resulting no late-back. |
| 2: | Randomly choose a destination route r′ to relocate customers starting from c. |
| 3: | Determine the maximum number kₘₐₓ customers that can be relocate without violating time |
| | windows in r′. |
| 4: | Perform relocate a random number k, 1 ≤ k ≤ kₘ from r to r′ starting from customer c. |

Algorithm 10 Handling Early-visit Violation with RELOCATION move

Require: A route r = {d = c₀, c₁, . . . , cₘ, d} with early-visit customers.

| | |
|---|---|
| 1: | Determine the last customer c [symbol] in the route that has early-visit violation. |
| 2: | Select randomly a customer cᵢ in the path from the depot to c₀ to cᵢ₋₁. |
| 3: | Select a neighbor customer c [symbol] in a some other route r′ of the customer cᵢ. |
| 4: | Determine the maximum number kₘ of customers starting from cₘ that can be removed from |
| | r′ and insert between cᵢ and cᵢ₊₁. |
| 5: | Relocate k customers where 1 ≤ k ≤ kₘ from r′ to r and insert them after cᵢ. |

[symbol]

indicates data missing or illegible when filed

Algorithm 11 Handling late-visit violation with RELOCATION move

Require: A route r with late-visit customers.

| | |
|---|---|
| 1: | Determine the set of customers (c [symbol] = d, c₁, c₂, . . . , cₘ} where cₖ ∈ r that has late-visit violations. |
| 2: | Randomly choose a customer c between two customers c [symbol] and c [symbol] . |
| 3: | Determine the maximum number kₘₐₓ customers that can be relocate without violating time |
| | windows in r′. |
| 4: | Perform relocate a random number k, 1 ≤ k ≤ kₘₐₓ from r to r′ starting from customer c. |

[symbol]

indicates data missing or illegible when filed

To help escape local optima, we implement multi-route moves which allow to involves more than 3 routes. Consider a set of routes {r₀, r₁, . . . , rₘ} where rᵢ/=rⱼ for all 0≤j<m, we want to perform a move that allows us to remove lₖ customers from the position pₖ of the route rₖ and insert them in to the route rₖ₊₁ at the position pₖ₊₁ for all 0≤k≤m−1. If r₀=rₘ, the move is called cyclic-exchange move; otherwise if r₀/=rₘ, then the move can be called an acyclic-exchange move.

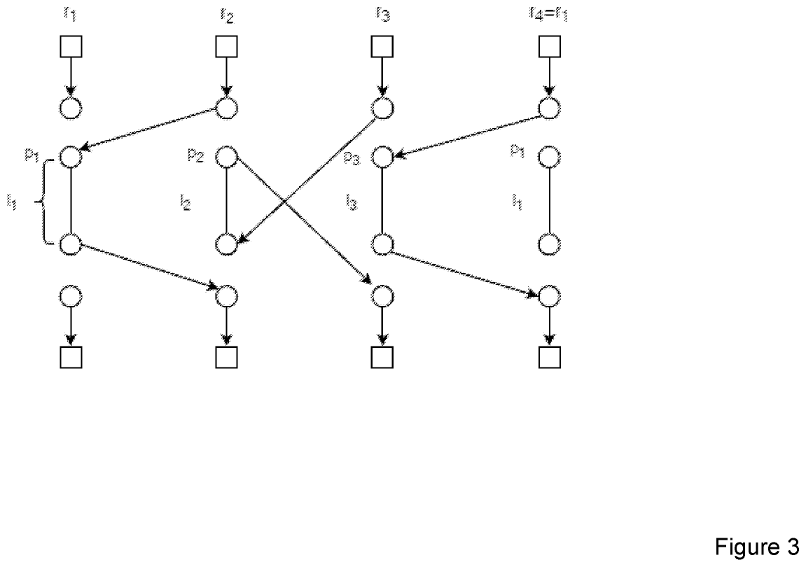

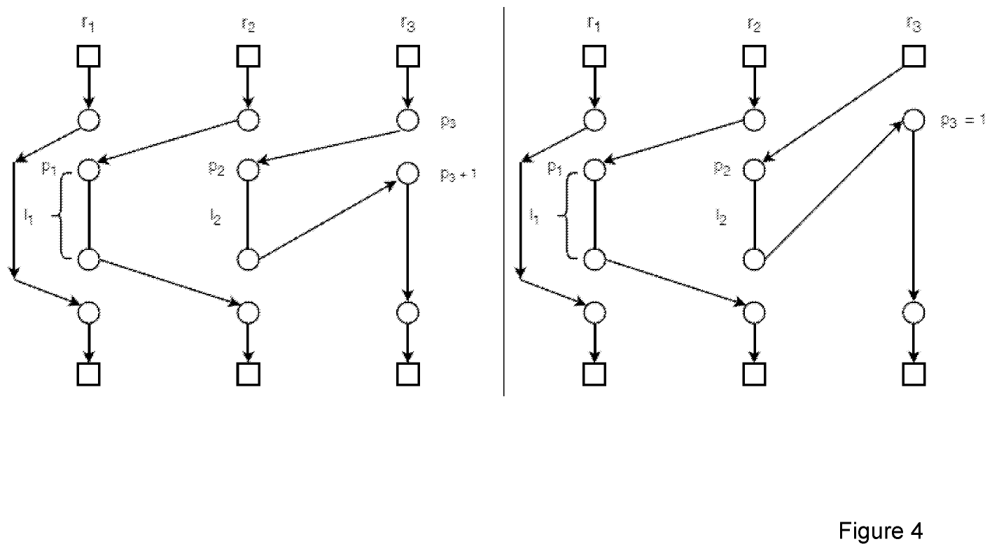

Let (d^{k}=c₀^{k}, c₁^{k}, . . . c_{qk}^{k}=dₖ) be the sequence depicts how customers are visited in route rₖ. Let rₖ(p,l) (l [symbol] 0) denote the subsequence cₚ_{ₖ}^{k}, cₚ_{ₖ}₊₁^{k}, . . . , cₚ_{ₖ}₊ₗ_{ₖ}₋₁ and rev(rₖ(p,l))) denote the reversed subsequence of rₖ(p,l), or cₚ_{ₖ}₊ₗ_{ₖ}₋₁^{k}, cₚ_{ₖ}₊ₗ_{ₖ}₋₂^{k}, . . . , cₚ_{ₖ}^{k}. When l=0, we let rₖ(p,l)=. The case l=0 only happens when rₘ≠r₀, and in this case, we try to insert some customer of rₘ₋₁ between pₘ and pₘ₊₁. We consider two remove/insertion choices when we move customers from rₖ₋₁ into rₖ for cyclic-exchange move first. In the first one, we replace rₖ(pₖ,lₖ) by rₖ₋₁(pₖ₋₁,lₖ₋₁), it means that route k becomes (dₖ=c₀^{k}, c₁^{k}, . . . , cₚ_{ₖ}₋₁^{k}, cₚ_{_{k−1}}^{k-1}, cₚ_{_{k−1}}₊₁^{k-1}, . . . , cₚ_{_{k−1}}₊ₗ_{_{k−1}}₋₁^{k-1}, cₚ_{ₖ}₊ₗ_{ₖ}^{k}, . . . , cᵣ_{ₖ}^{k}=dₖ). In the second case, we replace rₖ(pₖ,lₖ) by rev(rₖ₋₁(pₖ₋₁,lₖ₋₁)), route k becomes (d^{k}=c₀^{k}, c₁^{k}, . . . , cₚ_{ₖ}₋₁^{k}, cₚ_{_{k−1}}^{k-1}, cₚ_{_{k−1}}₊₁^{k-1}, . . . , cₚ_{_{k−1}}₊ₗ_{_{k−1}}₋₁^{k-1}, cₚ_{ₖ}₊ₗ_{ₖ}^{k}, . . . , cᵣ_{ₖ}^{k}=dₖ). In the case of a cyclic-exchange move, we must have r₀=rₘ, p₀=pₘ, l₀=lₘ and 1≤pₖ≤qₖ−1 where qₖ is the length of the route k. Otherwise, for an acyclic-exchange move, r₁/=rₘ, no customers are moved from the route rₘ, and we insert lₘ₋₁ customers from the route rₘ₋₁ between two customers pₘ and pₘ₊₁ where 0≤pₘ≤rₘ−1 by either original direction or reversed direction. FIG. 3 shows a schematic depiction of an acyclic move corresponding to 3 routes and FIG. 4 shows a schematic depiction of an acyclic move corresponding to 3 routes. The right figure of FIG. 4 is the case where we insert the subsequence (p₂, l₂) between the depot and the first customer of route r₃.

To identify which subset of routes and the corresponding subsequences of customers are candidates for a multi-route move, we define an improvement graph G(V,A) where

V={(v_{cl})|c∈C∧0≤Lₘₐₓ∧p_{c}+l−1≤l_{c}}

in which r_{c} is the route consisting of the customer c, p_{c} is the position of customer c in route r_{c}, and l_{c} is the length of the route r_{c}, correspondingly. To determine how we move customer locations between routes, arcs of the set A⊆V×V are established. For v_{c}1/1, v_{c}2/2∈V where c₁, c₂ are customers in routes r₁, r₂ with r₁/=r₂, a directed arc connecting v_{c}1/1 to v_{c}2/2 indicates that the subsequence of length lₖ from the customer k in route rₖ are removed from rₖ for k=1, 2; and the first removed subsequence is inserted into route r₂ after the position p₂−1 (if l₂>0 and p₂>0), or the first removed sequence is inserted between two positions p₂ and p₂+1 if l₂=0 and p₂≥0. The cost of the arc indicates how much we improve when we replace a subsequence in the second route by a subsequence of the first route.

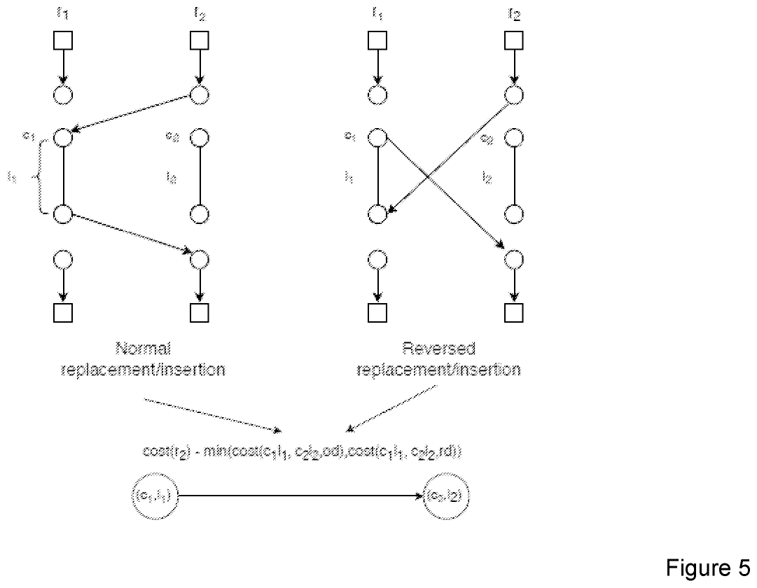

Let cost(r₂) be the cost of the route r₂ before the modification, cost(c₁l₁, c₂l₂, od) and cost(c₁l₁, c₂l₂, rd) be the cost of r₂ after the modification where cost(c₁l₁, c₂l₂, od) is the cost that we replace the subsequence (c₂, l₂) of r₂ by the subsequence (c₁, l₁) and keep the direction of (c₁, l₁) subsequence. cost(c₁l₁, c₂l₂, rd) is the cost that we replace the subsequence (c₂, l₂) of r₂ by the subsequence (c₁, l₁) and reverse the direction of (c₁, l₁) subsequence in route r₂. The cost of the arc ((c₁, l₁)(c₂, l₂)) is cost(r₂)−min(cost(c₁l₁, c₂l₂, od), cost(c₁l₁, c₂l₂, rd)). We associate with each arc a boolean value to determine whether min(cost(c₁l₁, c₂l₂, od), cost(c₁l₁, c₂₁₂, rd))=cost(cA c₂l₂, od) or cost(c₁l₁, c₂l₂, rd)). If the arc connecting v_{c}1/1 and v_{c}2/2 is selected, we will know how to replace the subsequence (c₂, l₂) by the subsequence (c₁, l₁). This is shown schematically in FIG. 5.

Consider a negative cost path (v_{c}_{₀}_{,l}_{₀}, v_{c}_{₁}_{,l}_{₁}, . . . v_{c}_{ₘ}_{,l}_{ₘ}) from a given node v_{c}_{₀}_{,l}_{₀} in the improvement network, we assume that cₖ belongs to the route rₖ and rᵢ≠rⱼ for all 0≤i<j≤m−1. If rₘ=r₀ and lₘ=l₀, it is corresponds to an improved cyclic-exchange move. Otherwise, if rₘ≠r₀ and lₘ=0, it corresponds to an improved acyclic-exchange move. To find a negative cost path starting from a given node v_{c}_{₀}_{,l}_{₀}, we rely on the dynamic program approach.

Given a starting node v₀=v_{c}_{₀}_{,l}_{₀}, Let ƒ(v,m) be the smallest cost of all paths of length m, v₀, v₁, . . . , vₘ=v, starting from the mode v₀=v_{c}_{₀}_{,l}_{₀} and ends at v where vₖ=vᵣ_{ₖ}_{,l}_{ₖ}∈V, cₖ∈rₖ, and rᵢ≠rⱼ for 1<i<j≤m; and let r(v,m)={r₁, r₂, . . . , rₘ} be the set of routes mentioned previously where cₖ∈rₖ. Let ƒ(v₀,0)=0 and r(v₀,0)=∅, we update ƒ(v,m)=min_{(v′,v)}{ƒ(v′,m−1)+cost(v′,v) if r_{v′}∉r(v_{c′l′},m−1) (*) where rᵥ where v=(c,l) denote the route that serves the customer c; and r(v,m)=r(v*,m−1)∪{r_{c}} where v* is the one that minimizes (*).

Algorithm 12 (see below) summarizes how we heuristically find a negative cost path or a negative cost cycle starting from the node vₛ. Step 1 defines the base cases for the dynamic programming. Step 2 initializes a set that maintains a set of so-called active vertices which are candidate vertices for a negative cycle or a negative path. We maintain the invariant that for each vertex v in the candidate vertex set Φ, given the current iteration m, there is a disjoint-route path of length m−1 from vₛ to v with non-negative cost. This condition is true for the base case. At each iteration m, assume that v=(c,l) is the current active node in Φ that is being considered, if v=vₛ or l=0, it means that we successfully a negative disjoint-route cycle or a negative disjoint-route path of length m−1, so we terminate the search. Otherwise, we try to generate disjoint-route paths of length m. We only consider an arc (v,v¹)∈A where disjoint route condition is met, rv1∉r(v, m−1) (step 7), and a negative path cost condition is still satisfied (step 8). In this case, we update the labels (Steps 10-12). prev is used to store trace back information that helps us build the path from the starting node vₛ to the node v. If the path corresponds to an improved cyclic-exchange move or an improved acyclic-exchange move (Step 13), we stop the search and return information.

Algorithm 12 NEGATIVE-CYCLE-SEARCH(G,V)

Require: the improvement graph, G(V,A), and a starting node vₛ = (c₀,l₀) where l₀ > 0.

| | |
|---|---|
| 1 | Let f(vₛ, 0) = 0 and r(vₛ, 0) = ∅ |
| 2: | Φ = {vₛ} {Set of active nodes} |
| 3: | for m=1 to MAX_CYCLES do |
| 4: | Ξ ← ∅ {the temporary active nodes} |
| 5: | for all v = (c,l) ∈ Φ do |
| 6: | for all (v,c′) ∈ A do |
| 7: | if r′_{c} ∉ r(v,m − 1) then |
| 8: | if f(v,m − 1) + e(v,v′) < 0 then |
| 9: | if v′ ∉ Ξ or f(v,m − 1) + c(v,v′) < f(m,v′) then |
| 10: | f(v′,m) ← f(v,m − 1) + cost(v,v′) |
| 11: | Ξ ← Ξ∪ {v′} |
| 12: | prev(v′,m) ← v |
| 13: | if v = v [symbol] or l = 0 then |
| 14: | return (v,m − 1) and prev |
| 15: | end if |
| 16: | end if |
| 17: | end if |
| 18: | end if |
| 19: | end for |
| 20: | end for |
| 21: | Φ ← Ξ |
| 22: | end for |
| 23: | return null |

[symbol]

indicates data missing or illegible when filed

Algorithm 13 (see below) shows how the multi-route move is used. For each subproblem generated previously, we duplicate this subproblem and create a new thread that only perform multi-route moves. We first create an improvement graph. The search for improved multi-route moves is repeated until stopping condition is met (in this case, the 20-second running time mentioned above). For a random starting node vₛ=(c,l), if a negative disjount-route path or a negative disjoint-route cycle is found, we update the s. The improvement graph also needs to be updated, however, only part of improvement graph G which relates to the routes r₀, r₁, . . . , rₘ (the routes that the multi-route move involves) needs to be updated.

Algorithm 13 Multi route move

Require: A subproblem SP and its a asociated solution s

| | |
|---|---|
| 1: | Create an improvement graph G = (V,E) using routes and orders in SP and s. |
| 2: | while stopping condition is not met do |
| 3: | Select a random starting node v = (c,l) |
| 4: | ((v,m),prev)) ← NEGATIVE-CYCLE-SEARCH(G,V) |
| 5: | if (v,m),prev)) ≠ null then |
| 6: | Determine the nodes v₀, v₁, . . . , vₘ that result in an improved multi-route move using vₘ |
| | and prev. |
| 7: | Determine the set of routes r₀, r₁, . . . , rₘ inwhich vₖ = (cₖ,lₖ) and cₖ ∈ rₖ. |
| 8: | Update s using v₀, v₁, . . . , vₘ |
| 9: | Update improvement graph G using r₀, r₁, . . . , rₘ |
| 10: | end if |
| 11: | end while |

Vehicles and associated drivers are important and costly assets in logistics. Therefore, minimizing the number of vehicles in a solution is an important task in vehicle routing problems. The classic route-minimization approach, which works with static data, first tries to reduce the number of vehicles to a value X, and then try to establish a transportation plan using X vehicles. Since we are working with dynamic data, this approach is not suitable for our problem. Also, not all routes are available at the beginning, with new routes are released whenever it is necessary. To minimize the number of routes, we propose different strategies.

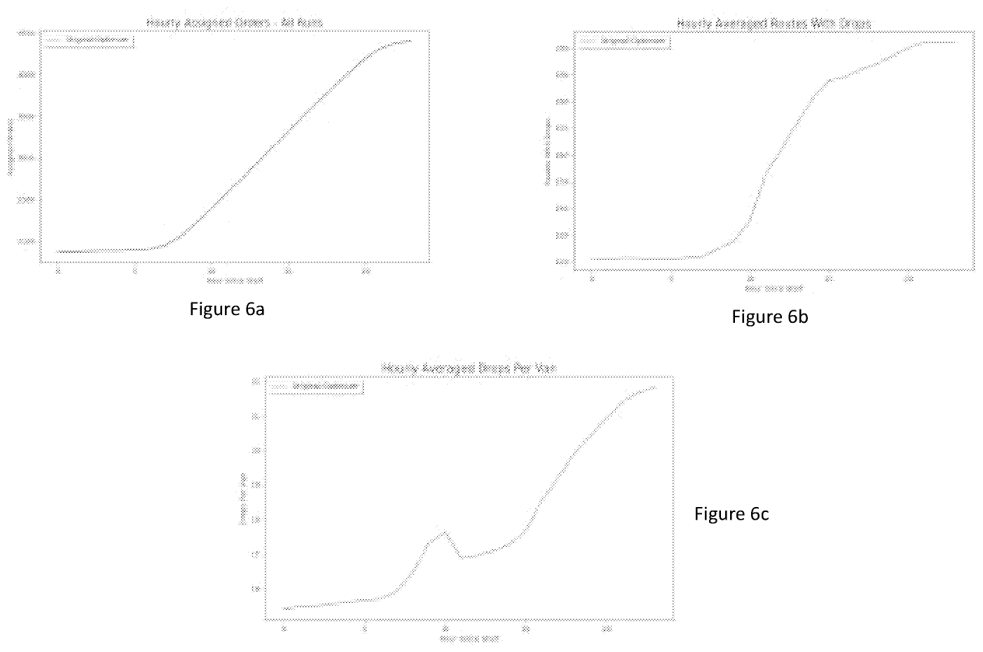

FIGS. 6a-6c show schematic depictions of the number of orders (FIG. 6a), the number of routes (FIG. 6b) and the drops per van value (FIG. 6c) for a particular instance from 00:00 AM to 23:59 PM. The last figure shows that there are moments that the value of drop per van decreases (e.g. from 11 AM to 12 AM). This is because the ratio of the new accepted orders and the numbers of new empty routes that are used to deliver those new orders is smaller than the current drop per van values. Therefore, there is a need to control the way new empty routes are used to deliver new confirmed orders.

Rather than trying to minimize the number of vehicles directly, the goal is to achieve this implicitly by maintaining drop-per-van value, α, which is the number of customers divided by the number of active routes. In other words, given the same number of customers, a solution with a higher drop-per-van value corresponds to a solution that requires fewer vehicles. The drop-per-van value decreases when an empty (or new) route is used. Thus, an empty route is only used, that is the allocation of a new vehicle to the delivery fleet, when predetermined conditions are met. Such conditions are developed to keep a as large as possible. Given a threshold α, the number of current customers nbCustomers, the number of active routes, nbActiveRoutes, an empty route will be used if

$$∝ \leq \frac{nb Customers + 1}{nb Active Routes + 1}$$

Therefore, we maintain the drop-per-van value condition when a new customer arrives. Briefly, when a customer c requests for an available time slot for their order o; the optimiser will check whether for each time slot w, there is a route r that can serve customer c during time slot w. Generally, all routes r will be used to check for availability. However, in this strategy, if using an empty route results in a worse drop per van value, or

$$\frac{nb Orders + 1}{nb Routes + 1} < ∝$$

then we will ignore this route. We can see that this strategy (algorithm 14, below) helps to maintain the drop-per-van value but it could prevent many orders from being booked because of the tight condition for using empty routes in slot booking.

Algorithm 14 Slot advertisement with Drop-per-van value

```
Require: A solution s, an order o that request for available slots, and drop-per-van
value threshold α
nbOrders ← number of orders in s
nbRoutes ← number of routes in s
Ω ←, the set of available slots for the order o to be delivered
for each time slot w in the set of possible slots do
  for each route r in s do
    $\frac{nbOrders + 1}{nbRoutes + 1} \geq α$
      Check whether this route r and be used to deliver the order o during time slot w
      If it is possible then we let Ω ← Ω ∪ w
    end if
  end for
end for
return a set of available time slots
```

The value of α may be adjusted dynamically during the execution of the optimization procedure. The value of α may be increased if

$$∝ \leq \frac{nb Customers + 1}{nb Active Routes + 1}$$

and the violation level is still met (that is the time window violation cost does not exceed some pre-determined percentage of the total cost). Otherwise, if the violation still exceeds some percentage of the total cost after several iterations of optimization, the value of α may be reduced. It will increase the chance of using an empty route and implicitly increases the chance of handling violations. Algorithm 15 gives an example of how the drop-per-van value may be reduced.

Algorithm 15 Drop-per-van value adjustment

```
Require: A solution s, current drop-per-van value α, time window violation
threshold β, level of changes p, q, and a parameter X
cₛ ← cost of the solutions s
c_{tw} violation time window cost of the solution s
$α \leq \frac{nbCustomers + 1}{nbActiveRoutes + 1} and \frac{{c}_{tw}}{{c}_{s}} \leq β$
  α ← α + p{increase drop per van value}
else
  $α \geq \frac{nbCustomers + 1}{nbActiveRoutes + 1} and \frac{{c}_{tw}}{{c}_{s}} \geq β$
    α ← α − q
  end if
end if
```

A limitation of the above approach is that the condition for using empty routes in slot advertisement is tight. Therefore, while it is possible that we can maintain a high drop per van value, the number of orders in the solution is smaller than usual since there are customers that can be served only by new routes. To resolve it, we try to relax the condition for using empty routes in slot advertisement by using a probabilistic approach. In other words, whenever an empty route is used to check whether we can serve a customer or not, the probability of using an empty route is smaller than α. Also, whenever we insert new orders into existing routes; the probability of using empty routes is at most α. Algorithm 16 demonstrates how the slot advertisement strategy with probability works.

Algorithm 16 Slot advertisement with probability for empty routes

```
Require: A solution s, an order o that request for available slots, and a threshold value α
  Ω ←: the set of available slots for the order o to be delivered
  for each time slot w in the set of possible slots do
    for each route r in s do
      if r is non-empty route or probability checking condition (*) is met (Algorithm 17) then
        Check whether this route r can he used to deliver the order o during time slot w
        If it is possible, update Ω ← Ω∪w
      end if
    end for
  end for
  return Ω
```

We have multiple options to choose whether we enable or disable using empty routes for slot advertisement for each customer or for all customers in an optimization cycle (e.g. 20 seconds). The first option means that for each customer, we generate a random number and if this random number is smaller than α, we allow to use empty route for the slot advertisement requested by this customer. The second option means that we use the same policy for all customers.

Algorithm 17 Determine whether we allow empty routes
in slot advising or not

```
Require: Threshold value α
  Generate a random number r in the interval (0,1).
  if r < α then
    return true {allow to use empty routes}
  else
    return false {do not allow to use empty route}
  end if
```

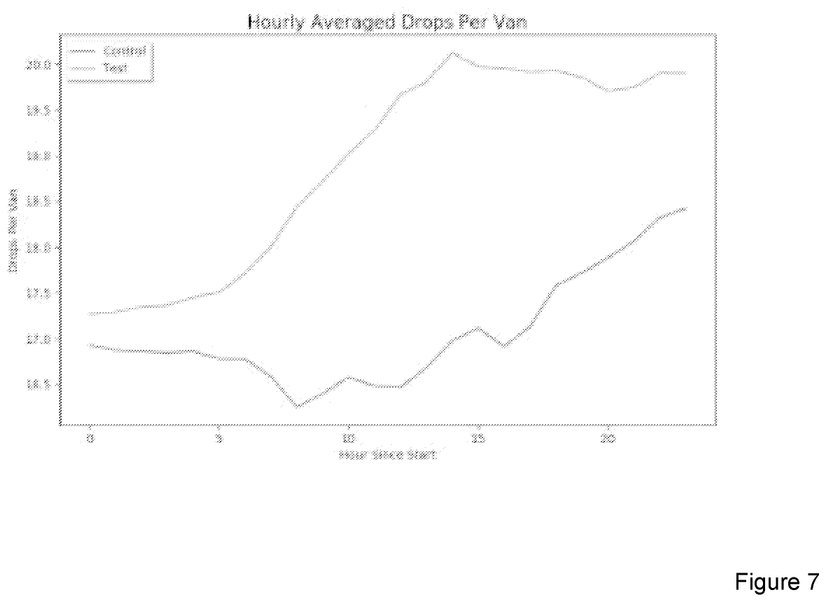

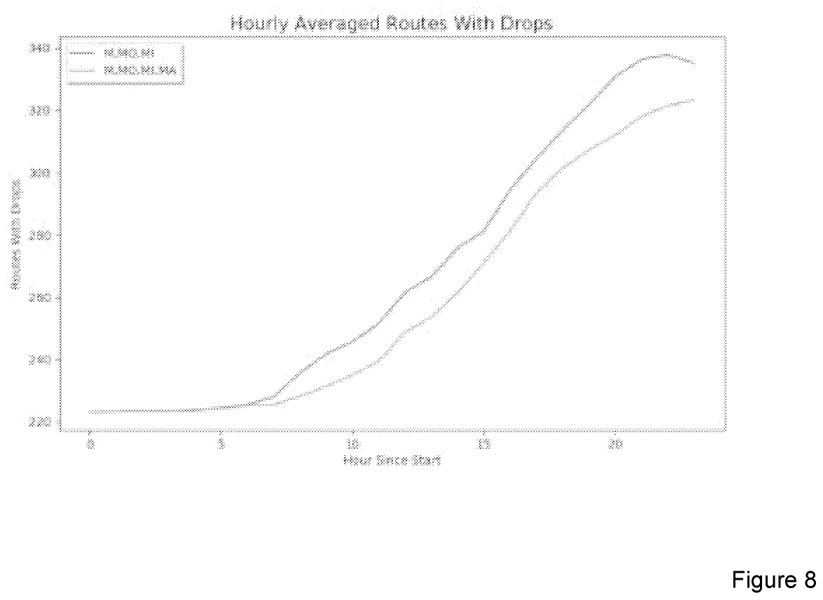

Computational simulations have shown that by determining routes in accordance with an embodiment of the disclosed, it is possible to book in approximately 16 additional customers for each 1000 customers being served. Furthermore, the decomposition and parallel optimisation approach enables larger size instances to be optimized rather than attempting to solve a single large problem. FIG. 7 shows a graphical depiction of the variation of the drop per van value through the day, showing that embodiments of the disclosed method provide a higher drop per van across the whole day. FIG. 8 shows a graphical depiction of the variation of the number of routes with drops. It can be seen that early in the day the values are approximately equal but as the day progresses, embodiment of the disclosed method allow the customer locations to be allocated to a smaller number of routes.

Many modifications and variations can be made to the embodiments described above, without departing from the scope of the present invention.

With respect to computer-implemented embodiments, the description provided may describe how one would modify a computer to implement the system or steps of a method. The specific problem being solved may be in the context of a computer-related problem, and the system may not be meant to be performed solely through manual means or as a series of manual steps. Computer-related implementation and/or solutions may be advantageous in the context of some embodiments; at least for the reasons of providing scalability (the use of a single platform/system to manage a large number of inputs and/or activities); the ability to pull together quickly and effectively information from disparate networks; improved decision support and/or analytics that would otherwise be unfeasible; the ability to integrate with external systems whose only connection points are computer-implemented interfaces; the ability to achieve cost savings through automation; the ability to dynamically respond and consider updates in various contexts (such as quickly changing order flow or logistical conditions); the ability to apply complex logical rules that would be infeasible through manual means; the ability for orders to be truly anonymous; among others.

Using electronic and/or computerised means can provide a platform that may be more convenient, scalable, efficient, accurate, and/or reliable than traditional, non-computerised means. Further, systems may be computerised and the platform may advantageously be designed for interoperability, and manual operation may be difficult and/or impossible. Further, manual operation, even if feasible, is unlikely to achieve comparable efficiency and/or

Scalability may be useful as it may be advantageous to provide a system that may be able to effectively manage a large number of inputs, outputs and/or interconnections and/or integration with external systems.

The convenience and effectiveness of a solution may be valuable in the context of order fulfilment as individuals may have more information available to make better ordering and/or fulfilment decisions.

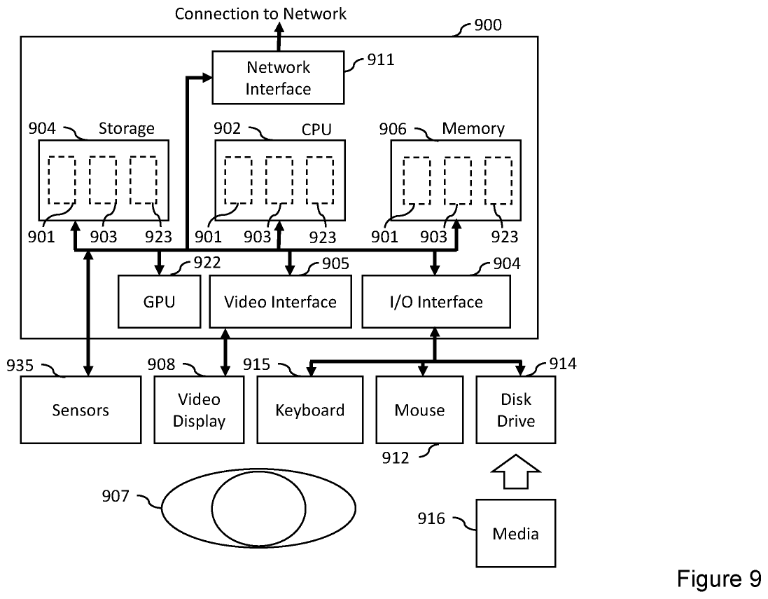

The present system and method may be practiced in various embodiments. A suitably configured computer device, and associated communications networks, devices, software and firmware may provide a platform for enabling one or more embodiments as described above. By way of example, FIG. 9 shows schematic depiction of a computer device 900 that may include a central processing unit (“CPU”) 902 connected to a storage unit 914 and to a random access memory 909. The CPU 902 may process an operating system 901, application program 903, and data 923. The operating system 901, application program 903, and data 923 may be stored in storage unit 914 and loaded into memory 909, as may be required. Computer device 900 may further include a graphics processing unit (GPU) 922 which is operatively connected to CPU 902 and to memory 906 to offload intensive image processing calculations from CPU 902 and run these calculations in parallel with CPU 902. An operator 907 may interact with the computer device 900 using a video display 908 connected by a video interface 905, and various input/output devices such as a keyboard 915, mouse 912, and disk drive or solid state drive 914 connected by an I/O interface 904. In known manner, the mouse 912 may be configured to control movement of a cursor in the video display 908, and to operate various graphical user interface (GUI) controls appearing in the video display 908 with a mouse button. The disk drive or solid state drive 914 may be configured to accept computer readable media 919. The computer device 900 may form part of a network via a network interface 911, allowing the computer device 900 to communicate with other suitably configured data processing systems (not shown). One or more different types of sensors 935 may be used to receive input from various sources.

The present system and method may be practiced on virtually any manner of computer device including a desktop computer, laptop computer, tablet computer, cloud computing platform or wireless handheld. The present system and method may also be implemented as a computer-readable/useable medium that includes computer program code to enable one or more computer devices to implement each of the various process steps in an embodiment of the disclosed method. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory (volatile, non-volatile, or any combination of the two) associated with a computer and/or a storage system.

The mobile application may be implemented as a web service, where the mobile device includes a link for accessing the web service, rather than a native application.

The functionality described may be implemented to any mobile platform, including the Android platform, iOS platform, Linux platform or Windows platform.

In further aspects, the disclosure provides systems, devices, methods, and computer programming products, including non-transient machine-readable instruction sets, for use in implementing such methods and enabling the functionality described previously.

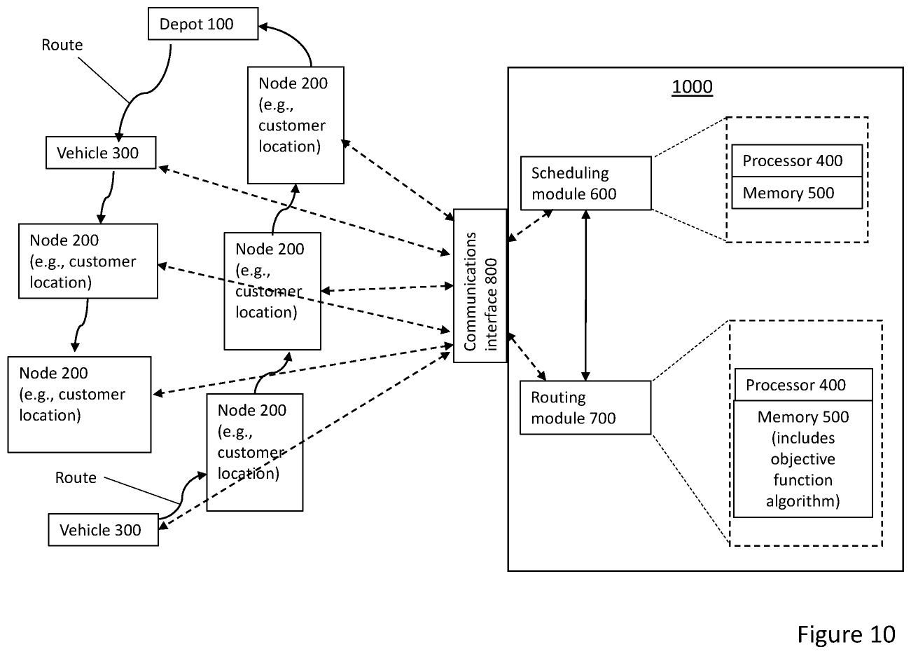

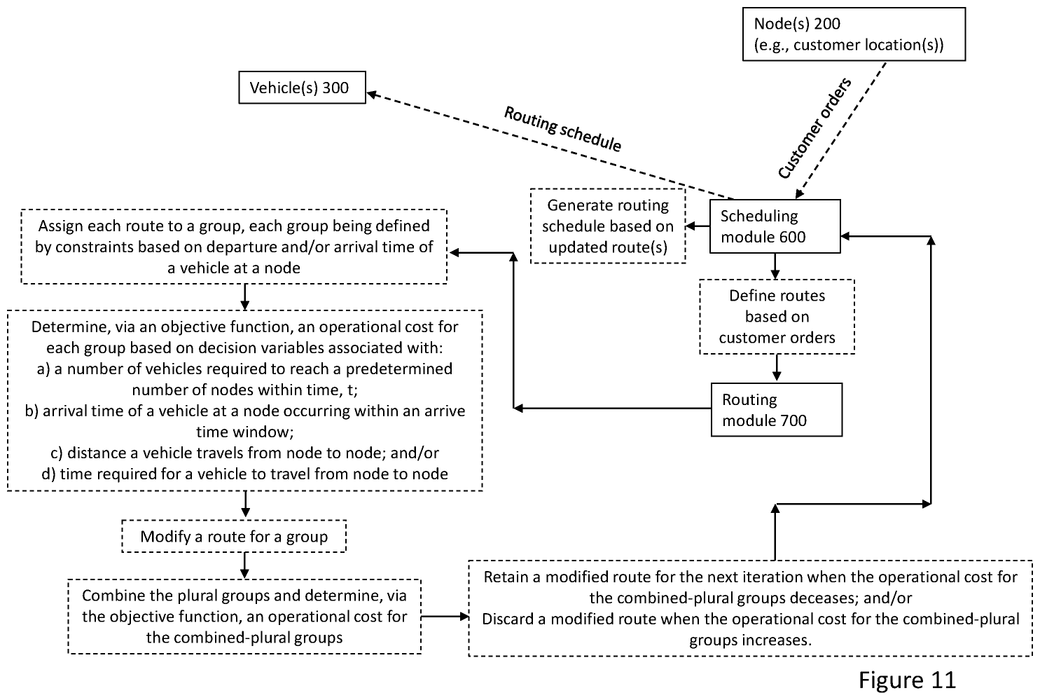

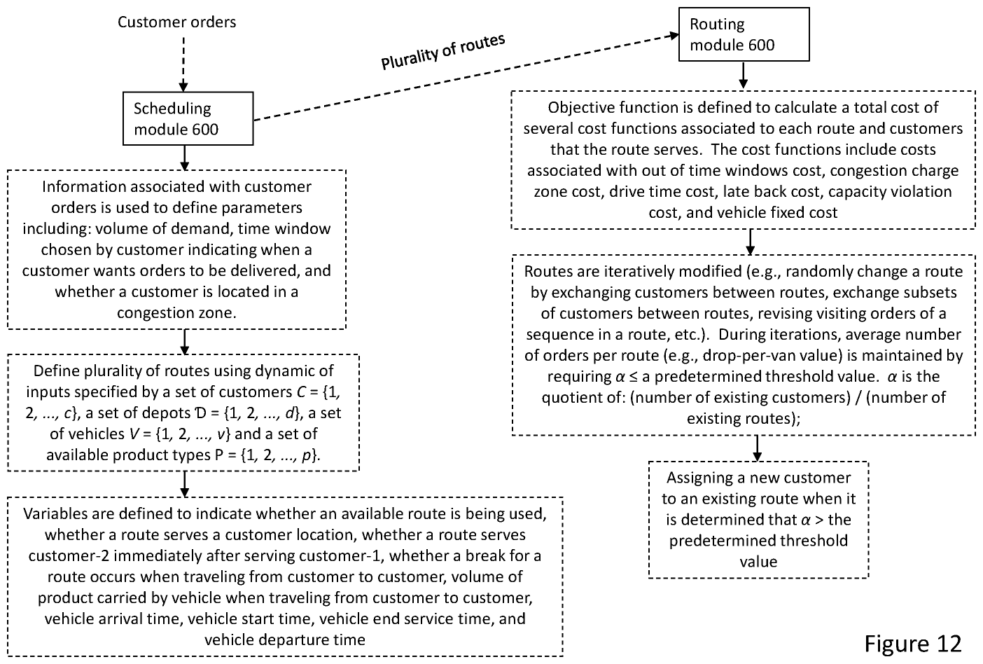

Referring to FIGS. 10-12, an exemplary embodiment includes a system 1000 for determining route for a vehicle 300. The route can be an optimised route as defined herein. The system 1000 can include one or more processors 400 disclosed herein. Any of the processors 400 can be in operative association with memory 500. The memory 500 can be any one or combination of the memories 500 disclosed herein. The memory 500 can have computer program instructions stored thereon that case the processor 400 to execute the methods disclosed herein. The algorithms disclosed herein can be embedded within the computer program instructions. The system 1000 can be used within, or part of, a multi-depot vehicle network. The system 1000 can be used to determine an optimal route (or routes) for any one or combination of vehicles 300 within the network.

Any one or combination of the vehicles 300 can have a processor 400 and a transceiver so as to facilitate communication (e.g., wireless communication) between the vehicle 300 and the system 1000. In this regard, the system 1000 can also have a transceiver for the same. This communication set up can allow for transmission of command signals from the system 1000 to any one or combination of vehicles 300. Via this communication network, any one of combination of vehicles 300 can provide feedback to the system 1000. The feedback can be location (e.g., via GPS tracking), arrival time at a customer location, departure time from a customer location, confirmation of delivery, etc.

Embodiments of the system 1000 and/or vehicle 300 can include a processor 400 or a processing module. Any of the processing modules discussed herein can include a processor 400 and associated memory 500. A processing module can be embodied as software and stored in memory 500, the memory 500 being operatively associated with the processor 400. A processing module can be a software or firmware operating module configured to implement any of the method steps disclosed herein. A processing module can be embodied as a web application, a desktop application, a console application, etc.

Any of the processors 400 discussed herein can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. It should be noted that use of processors 104 herein includes Graphics Processing Units (GPUs), Field Programmable Gate Arrays (FPGAs), Central Processing Units (CPUs), etc. Any of the memory 500 discussed herein can be computer readable memory configured to store data. The memory 500 can include a volatile or non-volatile, transitory or non-transitory memory (e.g., as a Random Access Memory (RAM)), and be embodied as an in-memory, an active memory, a cloud memory, etc. Embodiments of the memory 500 can include a processor module and other circuitry to allow for the transfer of data to and from the memory 500, which can include to and from other components of a communication system. This transfer can be via hardwire or wireless transmission. The communication system can include transceivers, which can be used in combination with switches, receivers, transmitters, routers, gateways, wave-guides, etc. to generate a communications interface 800 that facilitates communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

Any one or combination of vehicles 300 can be a manually operated vehicle, a semi-autonomously operated vehicle, or a fully autonomous vehicle. The system 1000 can transmit optimal route(s) to a vehicle 300 for: 1) consideration by the operator of the vehicle 300, 2) display of the optimal route(s) via a display, 3) control of the vehicle (e.g., cause the vehicle to follow the optimal route(s), etc.

In some embodiments, the vehicle 300 can be controlled by a remote computer device (configured using one or more processors 400 and memory 500) associated with the system 1000. For instance, the computer device can be in communication with the vehicle 300 via a wireless connection to facilitate data transmissions between the computer device and the vehicle 300. In addition, any of the vehicle 300 can have an application programming interface (API) and/or other interface configured to facilitate the computer device that is in communication with the vehicle 300 executing commands and controlling aspects of the vehicle 300. Embodiments of the computer device can be programmed to generate a user interface configured to facilitate control and display of various operational aspects of the vehicle 300.

In an exemplary embodiment, the system includes a scheduling module 600 configured to define at least one route. Each route includes a node 200. A node 200 can be an expected stop (e.g., customer location of a delivery route, a depot 100, a charging or re-fueling station, etc.). As orders are placed by customers, the scheduling module 600 creates nodes 200 and defines a route(s) for vehicle(s) 300 to follow in order to satisfy the delivery. Parameters, such as delivery times, distance between nodes 200, number of vehicles 300 available, etc. are used to define route(s). It is contemplated for there to be more than one vehicle 300 and for the vehicles 300 to be stationed at any one or combination of depots 100. The depots 100 are facilities or marshalling areas for the vehicles 300. Depots 100 can be located in a distributed manner. Thus, additional parameters used to define routes include number of depots 100, distance of a node 200 from a depot 100, number of vehicles 300 at each depot 100, etc.

The system includes a routing module 700. The routing module 700 configured to iterate a route determination process. An exemplary routing process can be as follows. The routing module 700 assigns each route to a group. Each group can be defined by constraints based on departure and/or arrival time of a vehicle 300 at a node 200. Thus, each route can be assigned to a group based on departure and/or arrival time of a vehicle 300 at a node 200. Any one or combination of routes can be assigned to any one or combination of groups. The routing module 700 determines, via an objective function, an operational cost for each group based on decision variables. The decision variables can include a number of vehicles 300 required to reach a predetermined number of nodes 200 within time, t. The decision variables can include arrival time of a vehicle 300 at a node 200 occurring within an arrive time window (e.g., a vehicle 300 must arrive at a node within a time span defined by t+/−t+1). The decision variables can include distance a vehicle 300 travels from node 200 to node 200. The decision variables can include time required for a vehicle 300 to travel from node 200 to node 200. The routing module 700 modifies at least one route for a group. The routing module 700 combines plural groups and determines, via the objective function, an operational cost for the combined-plural groups. The routing module 700 is configured to retain a modified route for the next iteration when the operational cost for the combined-plural groups deceases. In addition, or in the alternative, routing module 700 is configured to discard a modified route when the operational cost for the combined-plural groups increases. This can result in an optimisation of the plurality of routes. The optimised plurality of routes can be an optimised routing schedule having at least one route that has been optimised. The optimisation of any one or combination of routes can be based on a balancing of efficiency and meeting delivery requirements. Some factors include out of time window, travel time, late back, capacity violation, fixed cost, and congestion charge. These are variable used in the objective function and are defined herein.

The routing module 700 is configured to iterate the process for a predetermined time period. The predetermined time period can be between 20 seconds and 24 hours. After iterating for the predetermined time period, the routing module 700 transmits the plural routes to the scheduling module 600. Any one or combination of the routes may have been optimised. The scheduling module 600 generates a routing schedule (which may be an optimised routing schedule). The scheduling module 600 transmits the routing schedule to at least one vehicle 300 (e.g., transmits routes for all vehicles 300 to each vehicle 300). Alternatively, the scheduling module 600 transmits the route for a particular vehicle 300 to that vehicle (e.g., transmits route-1 to vehicle-1, route-2 to vehicle-2, etc.). Each vehicle 300, after receiving the route or routing schedule, can display the route/routing schedule, execute a delivery path based on the route/routing schedule, etc.

It is understood that assigning each route to a group can involve assigning at least one route to plural groups. In addition, modifying a route within a group can involve modifying plural routes within the group.

As already described each node 200 can represent a customer location of a delivery route. Parameters in the algorithms discussed herein encompass operational constraints such as order placement time, scheduled delivery time, etc. Thus, the scheduling module defines route(s) such that each route includes plural nodes arranged in a sequence. The sequence is dictated by when the vehicle 300 is expected to arrive at a customer location for delivery.

In a scenario in which each route includes plural nodes arranged in a sequence and the routing module 700 assigns at least one route to plural groups, the routing module can be configured to modify a route by moving a node 200 from a first route within a group to a second route within that group. In some embodiments, the routing module 700 is configured to randomly select the group by which the modification process is performed.

In a scenario in which each route includes plural nodes arranged in a sequence and the routing module 700 assigns at least one route to plural groups, the routing module 700 can be configured to modify a route by exchanging a subset of nodes 200 from a first route within a group with a subset of nodes 200 from a second route within that group.

In a scenario in which each route includes plural nodes arranged in a sequence and the routing module 700 assigns at least one route to plural groups, the routing module 700 can be configured to modify a route reordering a node 200 within the sequence.

The routing module 700 may be configured to modify a route for a group by utilizing a simulated annealing technique.

In some embodiments, the scheduling module 600 is configured to generate at least one additional route when a new node 200 is introduced to the system 1000. A new node 200 can be a new customer location based on a new or revised customer order. The scheduling module 600 can randomly assign the new node 200 to the at least one additional route. Alternatively, the scheduling module 600 can assign the new node 200 to an existing route of the plural routes. For instance, the scheduling module 600 may randomly assign the new node 200 to the at least one additional route when the scheduling module 600 determines α≤a predetermined threshold value, wherein α is the quotient of: (number of existing nodes)/(number of existing routes). The predetermined threshold value is defined by (number of existing nodes+1)/(number of existing routes+1).

Embodiments can relate to a method for determining an optimal route for a vehicle 300. The method can involve:
a) defining plural routes, each route including a node 200;
b) assigning each route to a group, each group being defined by constraints based on departure and/or arrival time of a vehicle 300 at a node 200;
c) determining an operational cost for each group;
d) modifying a route for a group; and
e) combining the plural groups and determining an operational cost for the combined-plural groups.

The method can involve iterating steps a)-e). During the iteration, the method involves: retaining a modified route for the next iteration when the operational cost for the combined-plural groups deceases; and/or discarding a modified route when the operational cost for the combined-plural groups increases.

As noted herein, the operational cost for each group and the operational cost for the combined-plural groups can be determined via an objective function. The operational cost for each group can be determined based on decision variables associated with:
1) a number of vehicles 300 required to reach a predetermined number of nodes 200 within time, t;
2) arrival time of a vehicle 300 at a node 200 occurring within an arrive time window;
3) distance a vehicle 300 travels from node 200 to node 200; and/or
4) time required for a vehicle 300 to travel from node 200 to node 200.

When a new node 200 is introduced, the method involves generating an additional route and randomly assigning the new node 200 to the additional route when it is determined that a a predetermined threshold value, wherein α is the quotient of: (number of existing nodes)/(number of existing routes). The method involves assigning the new node 200 to an existing route of the plural routes when it is determined that α>the predetermined threshold value.

As can be appreciated from the present disclosure, embodiments can relate to a system 1000 for minimizing a number of vehicles 300 to service customers. The system 1000 can include a processor 400. The processor 400 can be configured to define plural routes. Each route can include plural customer locations 200 arranged in a sequence. When a new customer location 200 is introduced to the system 1000, the processor 400 generates an additional route and randomly assigns the new customer location 200 to the additional route when the processor 400 determines α≤a predetermined threshold value, wherein α is the quotient of: (number of existing customer locations)/(number of existing routes). The processor 400 can be configured to assign the new customer location 200 to an existing route of the plural routes when the processor 400 determines α>the predetermined threshold value.

The foregoing description of embodiments of the invention has been presented for the purpose of illustration and description. It is not intended to be exhaustive or to limit the invention to the precise form disclosed.

1. A method of routing a plurality of vehicles, each of the plurality of vehicles being assigned to one of a plurality of depots, the method comprising the steps of:
a) defining a plurality of routes, each of the plurality of routes comprising a plurality of customer locations, wherein the plurality of customer locations are arranged in a sequence;
b) assigning each of the plurality of routes to one of a plurality of groups of routes;
c) for each of the plurality of groups, modifying one or more of the plurality of routes which comprise that group;
d) determining the operational cost for each of the plurality of groups;
e) combining each of the groups to determine the operational cost for the plurality of routes;
f) executing steps a) to e) within a predetermined time period and repeating steps a) to e) iteratively such that if there is a decrease in the operational cost for the plurality of routes then the modified routes generated in step c) are retained for the subsequent iteration;
g) updating the plurality of routes based on step f) and transmitting the updated plurality of routes to a vehicle.

2. The method according to claim 1, comprising:
h) controlling a vehicle using the updated plurality of routes.

3. The method according to claim 1, wherein if there is an increase in the operational cost for the plurality of routes then the modified routes generated in step c) are discarded for the subsequent iteration.

4. The method according to claim 1, wherein for each of the plurality of groups the one or more modified routes are selected randomly from the plurality of routes which comprise each group.

5. The method according to claim 1, wherein step c) comprises selecting one or more routes from each group of routes and moving one or more customer locations from a first route in a group of routes to a second route in that group of routes.

6. The method according to claim 1, wherein step c) comprises selecting one or more routes from each group of routes and re-ordering one or more customer locations in the selected route(s).

7. The method according to claim 1, wherein step c) comprises selecting one or more routes from each group of routes and exchanging a subset of customer locations from a first route in a group of routes with a subset of customer locations from a second route in that group of routes.

8. The method according to claim 1, wherein if a new customer location is to be inserted into a route in step a), the customer location is inserted into a new route.

9. The method according to claim 8, wherein a new customer location may be randomly inserted into a new customer route in step a).

10. The method according to claim 9, wherein a new customer location is inserted into a new customer route in step a) if a randomly generated number is less than predetermined threshold value.

11. The method according to claim 1, wherein if a new customer location is to be inserted into a route in step a), the customer location is inserted into an existing route.

12. The method according to claim 1, wherein step c) involves a process of simulated annealing.

13. A system for determining a route for a vehicle, the system comprising:
a scheduling module configured to define plural routes, each route including a node;
a routing module configured to determine a route for a vehicle by iteratively performing:
assign each route to a group, each group being defined by constraints based on departure and/or arrival time of a vehicle at a node;
determine, via an objective function, an operational cost for each group based on decision variables associated with:
a number of vehicles required to reach a predetermined number of nodes within time, t;
arrival time of a vehicle at a node occurring within an arrive time window;
distance a vehicle travels from node to node; and/or
time required for a vehicle to travel from node to node;
modify a route for a group;
combine the plural groups and determine, via the objective function, an operational cost for the combined-plural groups;
wherein the routing module is configured to:
retain a modified route for the next iteration when the operational cost for the combined-plural groups deceases; and/or
discard a modified route when the operational cost for the combined-plural groups increases.

14. The system according to claim 13, wherein:
the scheduling module is configured to generate at least one additional route when a new node is introduced to the system and randomly assign the new node to the at least one additional route; or
the scheduling module is configured to assign the new node to an existing route of the plural routes.

15. The system according to claim 13, wherein:
the scheduling module is configured to randomly assign the new node to the at least one additional route when the scheduling module determines α≤a predetermined threshold value, wherein α is the quotient of: (number of existing nodes)/(number of existing routes).

16. The system according to claim 15, wherein:
the predetermined threshold value is defined by (number of existing nodes+1)/(number of existing routes+1).

17. A method for determining a route for a vehicle, the method comprising:
a) defining plural routes, each route including a node;
b) assigning each route to a group, each group being defined by constraints based on departure and/or arrival time of a vehicle at a node;
c) determining an operational cost for each group;
d) modifying a route for a group;
e) combining the plural groups and determining an operational cost for the combined-plural groups;
iterating steps a)-e), wherein the method:
retains a modified route for the next iteration when the operational cost for the combined-plural groups deceases; and/or
discards a modified route when the operational cost for the combined-plural groups increases.

18. The method of claim 17, wherein:
the operational cost for each group and the operational cost for the combined-plural groups are determined via an objective function.

19. The method of claim 17, the method comprising:
the operational cost for each group is determined based on decision variables associated with:
a number of vehicles required to reach a predetermined number of nodes within time, t;
arrival time of a vehicle at a node occurring within an arrive time window;
distance a vehicle travels from node to node; and/or
time required for a vehicle to travel from node to node.

20. The method of claim 17, wherein when a new node is introduced the method involves:
generating at least one additional route and randomly assigning the new node to the at least one additional route when it is determined that α≤a predetermined threshold value, wherein α is the quotient of: (number of existing nodes)/(number of existing routes);
assigning the new node to an existing route of the plural routes when it is determined that α>the predetermined threshold value.
